(19) United States
(12) Patent Application Publication
(10) Pub. No.: US 2012/0178563 A1
(43) Pub. Date: Jul. 12, 2012

(54) Drive Belt System of Hybrid Engine

(75) Inventors: Chang-Min LEE, Gyeonggi-Do (KR); Kyung-Jun Yang, Gyeonggi-do (KR); Jae-Hyuk Jung, Daegu (KR)

(73) Assignees: Hyundai Motor Company, Seoul (KR); Gates Korea Co., Ltd, Dae-gu (KR); Kia Motors Corporation, Seoul (KR)

(21) Appl. No.: 13/172,616

(22) Filed: Jun. 29, 2011

(30) Foreign Application Priority Data
Jan. 6, 2011 (KR) 10-2011-0001241

(51) Int. Cl. F16H 7/12; F02B 63/04

(52) U.S. Cl. 474/110

(57) ABSTRACT

A drive belt system of a hybrid engine, may include a crankshaft pulley that may be disposed to be rotated by an engine, a hybrid starter generator (HSG) pulley that may be disposed with a distance from the crankshaft pulley and may be coupled to and rotated by a HSG that selectively starts the engine and generates electricity, an idler pulley that may be rotatably disposed at a position with a distance outwards from a first tangential line passing the crankshaft pulley and the, a drive belt that the crankshaft pulley, the and the idler pulley may be wrapped by the interior circumference thereof, a mechanical auto tensioner (MAT) that pushes the drive belt between the crankshaft pulley and the inwards from a second tangential line passing the crankshaft pulley and the to sustain the tension of the drive belt, and a hydraulic auto tensioner that pushes the drive belt between the crankshaft pulley and the idler pulley inwards to sustain the tension.

### CROSS-REFERENCE TO RELATED APPLICATION

The present application claims priority to Korean Patent Application No. 10-2011-0001241 filed on Jan. 6, 2011, the entire contents of which is incorporated herein for all purposes by this reference.

### BACKGROUND OF THE INVENTION

1. Field of the Invention

The present invention relates to a drive belt system of a hybrid engine. More particularly, the present invention relates to a drive belt system of a hybrid engine that an engine generates a driving torque and a drive motor assists the power.

2. Description of Related Art

Generally, an auxiliary system that is operated by a drive belt is disposed at an engine to drive the vehicle. The auxiliary system includes a water pump, a power steering pump, an air conditioner, and a generator.

A trend is that a crankshaft and the auxiliary system are operated by one drive belt, since one drive belt is used, the length thereof becomes longer and it is important to sustain the tension thereof.

A drive belt tensioner is used to sustain the tension of the drive belt and many kinds of the drive belt tensioner including a mechanical type and a hydraulic type are applied thereto.

A HSG (hybrid starter and generator) is applied to the vehicle that is recently being developed and the HSG system is applied a hybrid engine to start the engine and generate electricity. Meanwhile, while one drive belt is operating several pulleys, it is important to sustain the tension uniformly and to minimize a slip thereof.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a drive belt system of a hybrid engine having advantages of securely sustaining a tension of a drive belt during a starting and a generating and simultaneously minimizing a slip of the drive belt in a HSG (hybrid starter and generator) for starting and generating.

In an aspect of the present invention, the drive belt system of a hybrid engine, may include a crankshaft pulley that may be disposed to be rotated by an engine, a hybrid starter generator(HSG) pulley that may be disposed with a distance from the crankshaft pulley and may be coupled to and rotated by a HSG that selectively starts the engine and generates electricity, an idler pulley that may be rotatably disposed at a position with a distance outwards from a first tangential line passing the crankshaft pulley and the, a drive belt that the crankshaft pulley, the and the idler pulley may be wrapped by the interior circumference thereof, a mechanical auto tensioner (MAT) that pushes the drive belt between the crankshaft pulley and the inwards from a second tangential line passing the crankshaft pulley and the to sustain the tension of the drive belt, and a hydraulic auto tensioner that pushes the drive belt between the crankshaft pulley and the idler pulley inwards to sustain the tension.

The mechanical auto tensioner may include a MAT mounting bracket that may be mounted on the, a MAT arm, one end of which may be rotatably connected to the MAT mounting bracket by a hinge, a MAT pulley that may be rotatably mounted at the other end of the MAT arm and the exterior circumference thereof contacts the exterior circumference of the drive belt to be rotated thereby, and an elastic member that may be mounted to the MAT mounting bracket and elastically and pivotally supports one side of the MAT arm such that the MAT pulley elastically pushes the exterior circumference of the drive belt inwards the second tangential line.

When the rotates so as to start the engine, the rotation center of the MAT pulley moves inwards the second tangential line such that a wrap angle of the drive belt wrapped on the HSG pulley may be increased.

The drive belt system may further include a water pump pulley that may be disposed between the crankshaft pulley and the inwards the second tangential line and the exterior circumference thereof contacts the exterior circumference of the drive belt to be rotated thereby, wherein the MAT pulley may be disposed between the water pump pulley and the

The a hydraulic auto tensioner (HAT) mounting bracket that may be mounted on a chain cover, a HAT arm, one end of which may be pivotally connected to the chain cover by a hinge, a HAT pulley that may be rotatably mounted to the other end of the HAT arm and the exterior circumference thereof contacts the exterior circumference of the drive belt to be rotated thereby, and a hydraulic unit that supports one side of the HAT arm to push the exterior circumference of the drive belt inwards.

The HAT pulley may be disposed between the idler pulley and the crankshaft pulley.

When the HSG pulley receives torque from the engine to generate the electricity, the rotation center of the HAT pulley moves inwards such that the wrapped angle of the drive belt wrapped on the crankshaft may be increased.

The hydraulic unit may include an elastic member that elastically supports the HAT arm towards the drive belt, and a hydraulic unit body that pivotally supports the HAT arm.

The HSG synchronizes a rotation speed of the crankshaft with a rotation speed of a drive motor thereof in a predetermined condition.

A wrap angle of the drive belt wrapped on the HSG pulley may be larger than approximately 180 degrees.

A wrap angle of the drive belt wrapped on the crankshaft pulley may be larger than approximately 180 degrees.

In the drive belt system of the hybrid engine according to the present invention as describe above, the MAT increases a wrap angle of the drive belt wrapped on the HSG pulley during a starting and the HAT increases a wrap angle of the drive belt wrapped on the crankshaft pulley such that the tension of the drive belt is securely sustained and the slip is minimized.

Further, the arm of the MAT that is mounted on the HSG is hinged to the MAT mounting bracket such that the engine assemblage and the alignment thereof become easy.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a front view of a hybrid engine according to an exemplary embodiment of the present invention.

FIG. 2 is a front view showing a drive belt system of a hybrid engine according to an exemplary embodiment of the present invention.

FIG. 3 is a perspective view of a hydraulic pressure tensioner that is disposed at a drive belt system of a hybrid engine according to an exemplary embodiment of the present invention.

FIG. 4 is a perspective view of a mechanical tensioner that is disposed at a drive belt system of a hybrid engine according to an exemplary embodiment of the present invention.

FIG. 5 is a front view showing a condition that a drive belt system of a hybrid engine is not operating according to an exemplary embodiment of the present invention.

FIG. 6 is a front view showing a condition that an engine is started by a drive belt system of a hybrid engine according to an exemplary embodiment of the present invention.

FIG. 7 is a front view showing a condition that a hybrid engine generates electricity through a drive belt system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

The HSG is connected to a crankshaft of an engine through a drive belt to start the engine and reversely receives torque form the engine through the drive belt to charge a battery. Further, the HSG accurately adjusts a rotation speed of the engine so as to synchronize a speed of a drive motor with a rotation speed of the engine.

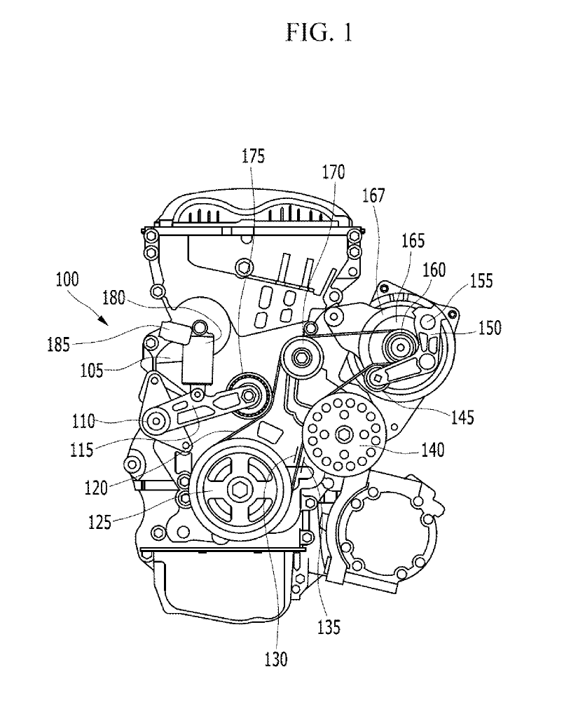

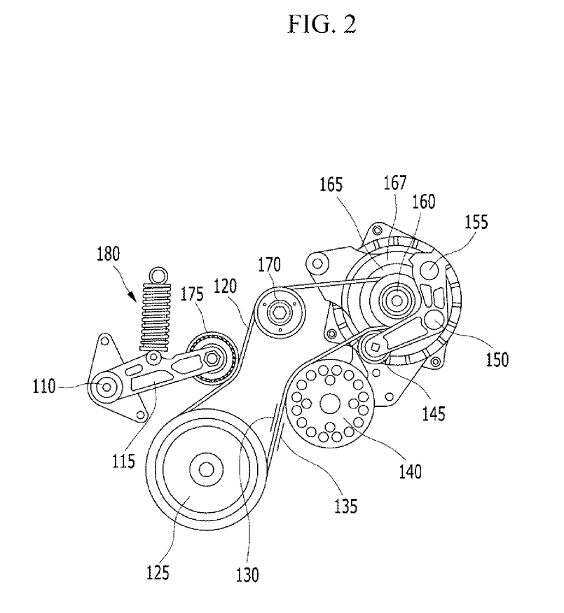

FIG. 1 is a front view of a hybrid engine according to an exemplary embodiment of the present invention, and FIG. 2 is a front view showing a drive belt system of a hybrid engine according to an exemplary embodiment of the present invention.

Referring to FIG. 1 and FIG. 2, an engine 100 of a hybrid engine includes a, a, a, an auxiliary drive belt 120, a, a, a, a, a MAT hinge 155, a 160, a, an, a and a.

In an exemplary embodiment of the present invention, the HAT denotes a hydraulic auto tensioner, the MAT denotes a mechanical auto tensioner, and the HSG denotes a hybrid starter and generator.

The crankshaft pulley 125 and the HSG pulley 160 are formed on the engine 100, the, the HSG pulley 160, and the, is disposed at the of the drive belt 120

The idler pulley 170 is disposed at a position of an upper side of a line passing the crankshaft pulley 125 and the HSG pulley 160 to be rotatably fixed to the chain cover 105.

The HAT mounting bracket 185 is fixed on the chain cover 105 of the engine 100, the HAT arm 115, the hydraulic unit 180, and the HAT pulley 175 are disposed at the HAT mounting bracket, the HAT pulley 175 is disposed at the outer circumference 135 of the drive belt 120 between the crankshaft pulley 125 and the idler pulley 170 at an opposite side of the HSG pulley 160 to push the drive belt 120 inwards

The water pump pulley 140, the MAT pulley 145, and the HAT pulley 175 are disposed on the exterior circumference 135 of the drive belt 120, and the water pump pulley 140 is disposed on the exterior circumference 135 of the drive belt 120 between the crankshaft pulley 125 and the MAT pulley 145 at an opposite side of the idler pulley 170 to push the drive belt 120 inwards.

The HAT pulley 175 is disposed between the idler pulley 170 and the crankshaft pulley 125 to push the drive belt 120 inwards, and the MAT pulley 145 is disposed between the water pump pulley 140 and the HSG pulley 160 to push the drive belt 120 inwards (from the outside to the inside thereof).

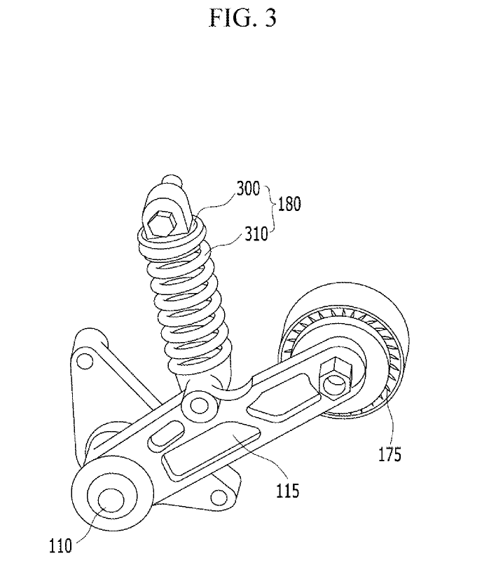

FIG. 3 is a perspective view of a hydraulic pressure tensioner that is disposed at a drive belt system of a hybrid engine according to an exemplary embodiment of the present invention.

Referring to FIG. 3, a hydraulic pressure type auto tensioner HAT includes the, the, the and the.

One end of the is rotatably fixed on the the, and the is rotatably disposed at the other end thereof.

The HAT arm 115 is elastically supported by the hydraulic unit 180 to push the drive belt 120 inwards such that the tension of the drive belt 120 is uniformly sustained.

The and a coli type, the 310 elastically supports the, and the securely sustains the movement of the spring.

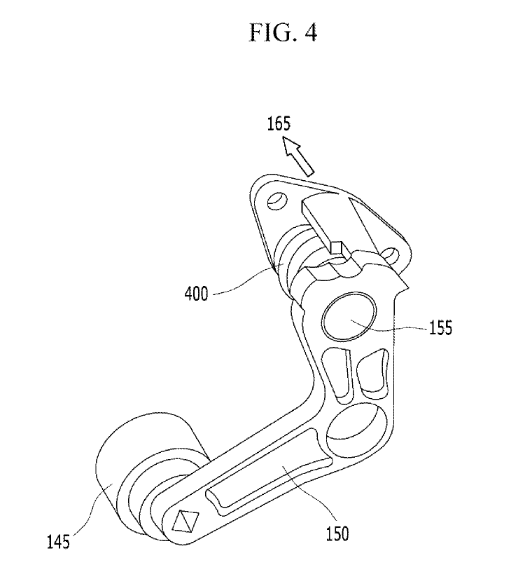

FIG. 4 is a perspective view of a mechanical tensioner that is disposed at a drive belt system of a hybrid engine according to an exemplary embodiment of the present invention.

Referring to FIG. 4, MAT (mechanical auto tensioner) includes the, the, the and.

The 90 degrees, the is disposed at one end thereof, and the is rotatably disposed at the other end thereof

The is fixed to a MAT mounting bracket 167 of the and the is rotatably disposed on the.

The is a coil spring wound on the, one end thereof is connected to the, and the other end is fixed to the.

The MAT spring 400 has the MAT arm 150 elastically rotated based on the MAT hinge 155 such that the MAT pulley 145 pushed the drive belt 120 inwards to sustain the elastic force of the drive belt 120.

In an exemplary embodiment of the present invention, one end of the is fixed to the HSG (hybrid starter and generator) such that the MAT is assembled compactly.

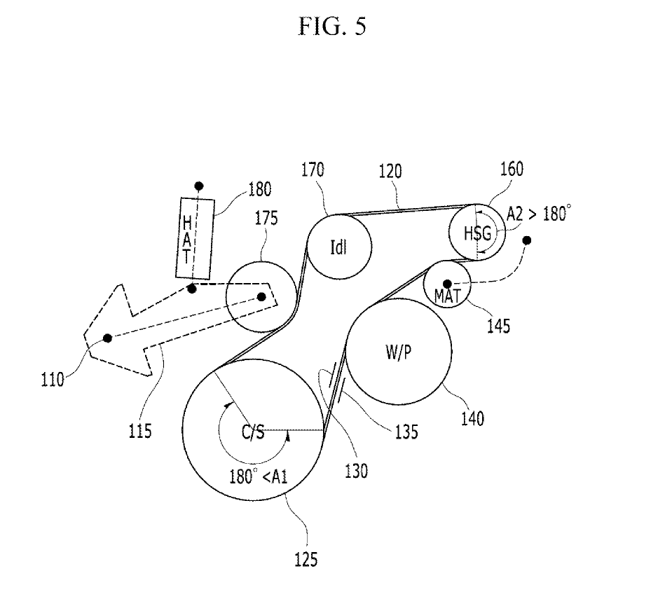

FIG. 5 is a front view showing a condition that a drive belt system of a hybrid engine is not operating according to an exemplary embodiment of the present invention.

Referring to FIG. 5, a wrap angle of the drive belt 120 wrapped on the is larger than 180 degrees and a wrap angle of the drive belt 120 wrapped on the crankshaft pulley 125 is larger than 180 degrees.

The HSG pulley 160 is rotated by the HSG and the HSG starts the engine 100 or generates electricity to charge a battery through a torque of the crankshaft pulley 125.

Particularly, in an exemplary embodiment of the present invention, since the wrap angle of the drive belt 120 wrapped on the and the wrap angle of the drive belt 120 wrapped on the are larger than 180 degrees, the slip of the with the and the slip of the with the are minimized during the engine starting or the battery charging.

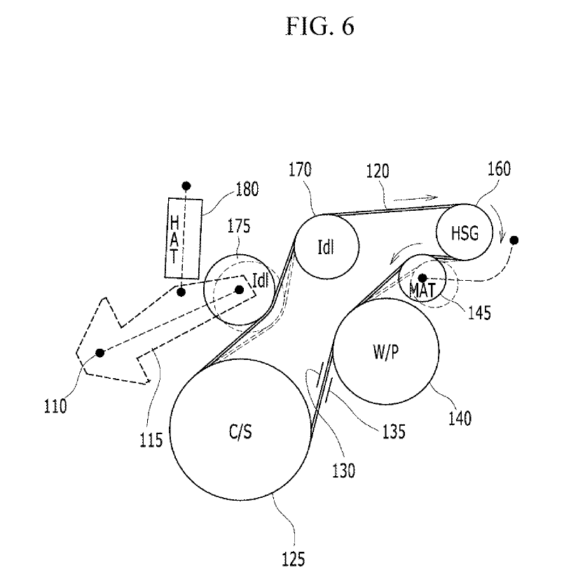

FIG. 6 is a front view showing a condition that an engine is started by a drive belt system of a hybrid engine according to an exemplary embodiment of the present invention.

Referring to FIG. 6, if the, a tension of the drive belt 120 between the and the is instantly increased and a tension of the drive belt 120 between the and the is instantly decreased.

Accordingly, the drive belt 120 moves inwards by elastic force of the to increase a wrapped angle of the drive belt 120 wrapped on the such that slip between the and the is minimized

The HSG pulley 160 that is disposed between the and the the and a movement of the HAT pulley 175 is minimized by damping force and elastic force of the hydraulic unit 180 of the HAT such that the tension of the drive belt 120 is tightly sustained.

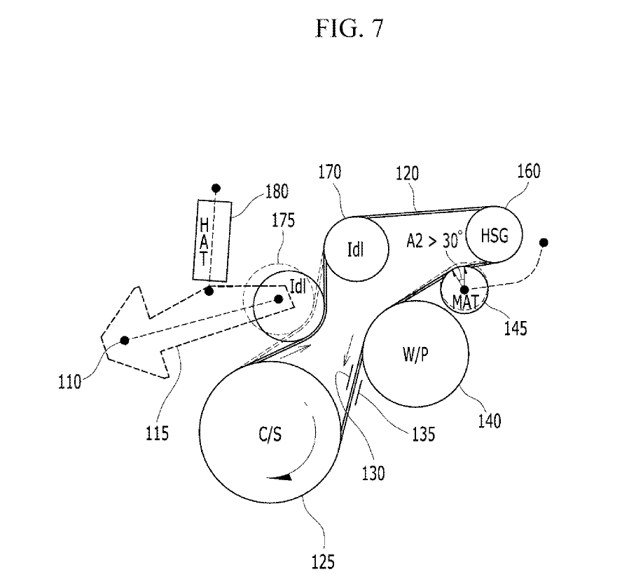

FIG. 7 is a front view showing a condition that a hybrid engine generates electricity through a drive belt system according to an exemplary embodiment of the present invention.

Referring to FIG. 7, the rotates in clockwise direction and the HSG generates electricity through the. Accordingly, a tension of the drive belt 120 from 160 to the is increased and a tension of the drive belt 120 from the to the is decreased.

Accordingly, the moves the drive belt 120 inwards by a damping force and elastic force thereof to increase a wrap angle of the drive belt 120 wrapped on the crankshaft pulley 125 such that the slip between the and the is minimized.

Further, because a wrap angle of the drive belt 120 wrapped on the is small as a 30 degrees, movement of the MAT pulley 145 by the drive belt 120 is minimized, although a tension of the drive belt 120 between the and the is increased.

Accordingly, a wrap angle of the drive belt 120 wrapped on the.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

For convenience in explanation and accurate definition in the appended claims, the terms “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A drive belt system of a hybrid engine, comprising:
a crankshaft pulley that is disposed to be rotated by an engine;
a hybrid starter generator(HSG) pulley that is disposed with a distance from the crankshaft pulley and is coupled to and rotated by a HSG that selectively starts the engine and generates electricity;
an idler pulley that is rotatably disposed at a position with a distance outwards from a first tangential line passing the crankshaft pulley and the;
a drive belt that the crankshaft pulley, the and the idler pulley are wrapped by the interior circumference thereof;
a mechanical auto tensioner (MAT) that pushes the drive belt between the crankshaft pulley and the inwards from a second tangential line passing the crankshaft pulley and the to sustain the tension of the drive belt; and
a hydraulic auto tensioner that pushes the drive belt between the crankshaft pulley and the idler pulley inwards to sustain the tension.

2. The drive belt system of the hybrid engine of claim 1, wherein the mechanical auto tensioner includes:
a MAT mounting bracket that is mounted on the ;
a MAT arm, one end of which is rotatably connected to the MAT mounting bracket by a hinge;
a MAT pulley that is rotatably mounted at the other end of the MAT arm and the exterior circumference thereof contacts the exterior circumference of the drive belt to be rotated thereby; and
an elastic member that is mounted to the MAT mounting bracket and elastically and pivotally supports one side of the MAT arm such that the MAT pulley elastically pushes the exterior circumference of the drive belt inwards the second tangential line.

3. The drive belt system of the hybrid engine of claim 2, wherein when the rotates so as to start the engine, the rotation center of the MAT pulley moves inwards the second tangential line such that a wrap angle of the drive belt wrapped on the HSG pulley is increased.

4. The drive belt system of the hybrid engine of claim 2, further comprising:
a water pump pulley that is disposed between the crankshaft pulley and the inwards the second tangential line and the exterior circumference thereof contacts the exterior circumference of the drive belt to be rotated thereby.

5. The drive belt system of the hybrid engine of claim 4, wherein the MAT pulley is disposed between the water pump pulley and the

6. The drive belt system of the hybrid engine of claim 1, wherein the a hydraulic auto tensioner (HAT) mounting bracket that is mounted on a chain cover;
a HAT arm, one end of which is pivotally connected to the chain cover by a hinge;
a HAT pulley that is rotatably mounted to the other end of the HAT arm and the exterior circumference thereof contacts the exterior circumference of the drive belt to be rotated thereby; and
a hydraulic unit that supports one side of the HAT arm to push the exterior circumference of the drive belt inwards.

7. The drive belt system of the hybrid engine of claim 6, wherein the HAT pulley is disposed between the idler pulley and the crankshaft pulley.

8. The drive belt system of the hybrid engine of claim 6, wherein when the HSG pulley receives torque from the engine to generate the electricity, the rotation center of the HAT pulley moves inwards such that the wrapped angle of the drive belt wrapped on the crankshaft is increased.

9. The drive belt system of the hybrid engine of claim 6, wherein the hydraulic unit includes:
an elastic member that elastically supports the HAT arm towards the drive belt; and
a hydraulic unit body that pivotally supports the HAT arm.

10. The drive belt system of the hybrid engine of claim 1, wherein the HSG synchronizes a rotation speed of the crankshaft with a rotation speed of a drive motor thereof in a predetermined condition.

11. The drive belt system of the hybrid engine of claim 1, wherein a wrap angle of the drive belt wrapped on the.

12. The drive belt system of the hybrid engine of claim 1, wherein a wrap angle of the drive belt wrapped on the.
